(19) United States
(12) Patent Application Publication
(10) Pub. No.: US 2009/0123792 A1
(43) Pub. Date: May 14, 2009

(54) HIGH-TEMPERATURE FUEL CELL STACK

(75) Inventors: Andreas Reinert, Dresden (DE); Michael Rozumek, Neubrandenburg (DE); Uwe Bergmann, Neustrelitz (DE); Jens Hafemeister, Neustrelitz (DE)

Correspondence Address: DICKINSON WRIGHT PLLC, 1875 Eye Street, NW, Suite 1200, WASHINGTON, DC, 20006, US

(73) Assignee: WEBASTO AG, Stockdorf (DE)

(21) Appl. No.: 12/295,171

(22) PCT Filed: Mar. 30, 2007
(86) PCT No.: PCT/DE2007/000573

§ 371 Date: Nov. 21, 2008

(30) Foreign Application Priority Data
Mar. 31, 2006 (DE) 10 2006 015 118.6

(51) Int. Cl. H01M 8/24; H01M 8/02

(52) U.S. Cl. 429/13; 429/34

(57) ABSTRACT

The invention relates to a high temperature fuel cell stack (10) retained by a temporary retaining device.

According to the invention it is contemplated that the temporary retaining device (12-22) consists of a plastic material burning at a temperature which is lower than the operating temperature of the high temperature fuel cell stack (10).

The invention also relates to a method for temporarily retaining a high temperature fuel cell stack (10) and a method for removing a temporary retaining device (12-22) of a high temperature fuel cell stack (10). The invention further relates to the use of per se known plastic elements (12-22) as a temporary retaining device for a high temperature fuel cell stack (10).

The invention relates to a high temperature fuel cell stack retained by a temporary retaining device. The invention further relates to a method for temporarily retaining a high temperature fuel cell stack and a method for removing a temporary retaining device of a high temperature fuel cell stack. The invention also relates to a special use of plastic components.

High temperature fuel cell stacks such as, for example, SOFC stacks, are manufactured or joined under a defined restraint. Said restraint has to be permanently maintained. Namely, the components and materials used in high temperature fuel cell stacks and having slightly different thermal expansion coefficients and the temperature difference of, for example, an operating and joining temperature of 850° C. as well as the ambient temperature in the cooled state result in internal tensions which may, for example, cause a peeling off of contact layers, a cracking of seals and therefore a deterioration of the performance of the fuel cell stack without a sufficient restraint. A permanent perpetuation of the restraint may, for example, mean that the restraint has to be maintained during the production of the high temperature fuel cell stack, during the dismantling from the oven, during the transport of the high temperature fuel cell stack, during the installation of the high temperature fuel cell stack in the respective system, during the transfer of the restraint to a final system retaining device, and during the operation of the high temperature fuel cell stack in the system. For these different phases different technologies for applying the retaining force are known. During the production of the high temperature fuel cell stack the restraint may, for example, be produced by applying a load. From DE 103 34 129 A1 the power and/or path controlled joining of the high temperature fuel cell stack by means of one or more actuators is known. If a permanent, internal fuel cell stack restraint by means of tie anchors and elastic elements or a restraint by means of rigid retaining elements comprising an integrated thermal expansion mechanism (see, for example, the WO 2004102706 A2 or CA 2453061 A1) is used said restraint can be used from the removal from the oven to the operation of the of the high temperature fuel cell stack, including the latter. The use of tie anchors of highly heat-proof steels, however, is very expensive and, in addition, poses the risk that a uniform restraint cannot be maintained over a longer period of time due to creep events. Elastic elements for compensating the creep events which will survive the high operating temperatures of, for example, 850° C., are also expensive or not even available. Therefore the elastic elements for compensating the creep events are often arranged outside of the insulation of the high temperature fuel cell stack. For this purpose in many cases openings in the insulation are required which may lead to a loss of heat.

From DE 103 08 382 B3 it is known to first retain the fuel cell stack using a temporary retaining device after the cooling in the oven, to then perform an insulation of the fuel cell stack, to provide a final retaining device outside of the insulation, and to then remove the temporary retaining device. According to the teachings of DE 103 08 382 B3 therefore openings have to be provided in the insulation to remove the temporary retaining device, and thereafter the corresponding orifices are filled with insulation material. Then the fuel cell stack can be activated. This solution is disadvantageous in that the manual removal of the temporary retaining device and the sealing of the orifices in the insulation result in expenses and costs and are detrimental to the integrity and the functionality of the insulation. Above that the fuel cell stack may easily be damaged during the removal of the temporary retaining device.

The invention is based on the object to eliminate these disadvantages.

Said object is solved by the features specified in the independent claims.

Advantageous embodiments and further developments of the invention will become obvious from the dependent claims.

The high temperature fuel cell stack according to the invention is based on the generic state of the art in that the temporary retaining device consists of a plastic material burning at a temperature which is lower than the operating temperature of the high temperature fuel cell stack. Owing to this solution it is possible to remove the temporary retaining device by a simple activation of the high temperature fuel cell stack, preferably by a residue-free combustion, after a final retaining device was provided, preferably outside of an insulation provided for in the meantime. In this way the elaborate and risky measures for removing the temporary retaining device of, for example, DE 103 08 382 B3 are eliminated.

In this connection it may advantageously be contemplated that the plastic material comprises polymeric plastic material, particularly polypropylene and/or polyethylene. Polypropylene may, for example, have a melting temperature of 132° C. while polyethylene can have a melting temperature of, for example, 163° C.; both polymeric plastic materials burn at higher temperatures.

In case of preferred embodiments of the high temperature fuel cell stack according to the invention it is contemplated that the temporary retaining device comprises at least one plastic screw, at least one plastic nut, at least one plastic strip, at least one plastic shell, at least one plastic rod and/or a shrinking foil. Basically all plastic elements are feasible which are suitable for applying the forces required for the restraint and burn at a temperature which is lower than the operating temperature of the high temperature fuel cell stack.

According to a preferred further development of the high temperature fuel cell stack according to the invention it is contemplated that the high temperature fuel cell stack comprises two at least substantially parallel end plates clamped towards each other by means of the temporary retaining device and that the temporary retaining device does not or only slightly protrude beyond the end plates. The end plates may, for example, be provided with protruding flaps in their corner sections, said flaps being provided with holes, respectively two of said holes being aligned with respect to each other and designed to accommodate countersunk head screw heads. In this case it is possible to provide virtually plane top and bottom sides of the high temperature fuel cell stack which, for example, enables a trouble-free stacking of a plurality of such fuel cell stacks.

The method for temporarily retaining a high temperature fuel cell stack according to the invention is characterised by the following step: retaining the high temperature fuel cell stack by means of a temporary retaining device consisting of a plastic material burning at a temperature which is lower than the operating temperature of the high temperature fuel cell stack.

In this way the basis for the execution of the method for removing a temporary retaining device of a high temperature fuel cell stack according to the invention explained below is provided.

In connection with the method for temporarily retaining a high temperature fuel cell stack according to the invention it is also preferred that the plastic material comprises polymeric plastic material, particularly polypropylene and/or polyethylene.

The method for removing a temporary retaining device of a high temperature fuel cell stack according to the invention is characterised by the following step: activation of the high temperature fuel cell stack and simultaneous combustion of the temporary retaining device.

With this solution the risky measures for removing the temporary retaining device known from the DE 10 308 382 B3 are avoided.

In connection with the method for removing the temporary retaining device according to the invention it is also preferred that the plastic material comprises polymeric plastic material, particularly polypropylene and/or polyethylene.

The invention further relates to the use of at least one plastic screw, at least one plastic nut, at least one plastic strip, at least one plastic shell, at least one plastic rod and/or of a shrinking foil as a temporary retaining device for a high temperature fuel cell stack.

In this connection as well it is preferable that the plastic material comprises polymeric plastic material, particularly polypropylene and/or polyethylene.

Preferred embodiments of the invention will be explained below by way of example with reference to the related drawings in which:

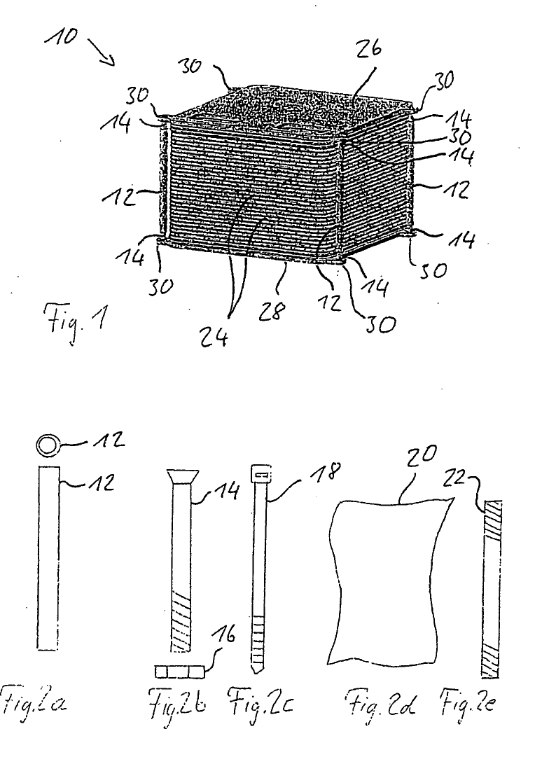

FIG. 1, is a perspective illustration of an embodiment of the high temperature fuel cell stack according to the invention to which the method for temporarily retaining a high temperature fuel cell stack according to the invention was applied and which is prepared for executing the method for removing a temporary retaining device according to the invention; and

FIGS. 2a to 2e, show various plastic elements which may, according to the invention, be used as a temporary retaining device for a high temperature fuel cell stack.

FIG. 1 shows a perspective illustration of an embodiment of the high temperature fuel cell stack 10 according to the invention. The illustrated fuel cell stack comprises, in a per se known manner, a plurality of repetitive elements 24 arranged between a top end plate 26 and a bottom end plate 28. The top end plate 26 and the bottom end plate 28 comprise flaps 30 in their respective corner sections, said flaps 30 being provided with a countersunk hole. In the embodiment shown in FIG. 1 the temporary retaining device is formed by four shells 12 (only three of which are visible) provided with an internal thread and eight screws 14 (of which only six are visible) provided with a countersunk head. The shells 12 provided with an internal thread as well as the screws 14 are made of a plastic material burning, preferably without residues, at a temperature which is lower than the operating temperature of the high temperature fuel cell stack which may, for example, be 850° C. The plastic material may, for example, comprise polymeric plastic materials such as polypropylene and/or polyethylene.

To obtain the state of the high temperature fuel cell stack shown in FIG. 1 it was first joined while being heated as, for example so, described in DE 103 34 129 A1 the content of which is to be understood to be part of the disclosure of the present description. Therefore the fuel cell stack is not exposed to a defined pressure during its production by applying a load as known from DE 103 08 382 B3 but by a power actuator. Furthermore said power actuator has the option to monitor the release path and to influence it by a variation of the compressive force. The force applied in this way is used during the joining process (fusing of the sealing material and joining the electric contacts) while cooling to the ambient temperature and until the transfer of the restraint to the temporary retaining device which is mounted after the joining and cooling, for example by carrying out the method for temporarily retaining a high temperature fuel cell stack according to the invention.

The temporary retaining device takes care that the fuel cell stack can be safely transported from the production site to the final destination in the fuel cell system and handled. After the installation in the fuel cell system a final retaining device is provided. It may be formed in a per se known manner, for example as specified in DE 195 066 690 A1, DE 103 08 382 D3 or JP 11007975 A. Particularly preferred is a restraint by means of an insulation arranged around the temporary retaining device.

Then the method for removing the temporary retaining device of a high temperature fuel cell stack according to the invention may be carried out. For this purpose the high temperature fuel cell stack only needs to be activated. During the heating to the operating temperature of, for example, 850° C. the temporary retaining device is burned and the required restraint is taken over by the final retaining device.

In FIGS. 2a to 2e possible plastic elements are shown which may form the temporary retaining device. FIG. 2a shows a shell provided with an internal thread. FIG. 2b shows a screw provided with an external thread and having a flush head as well as a hexagonal nut 16. FIG. 2c shows a strip-shaped retaining element in the form of a commercial cable binder 18. FIG. 2d schematically shows a piece of a shrinking foil 20 since a shrinking foil may also be used as a temporary retaining device. Finally a plastic rod 22 is shown in FIG. 2e which is provided with external threads at least at its end portions.

Principally the use of a plastic material for the temporary retaining device has, in particular, the following advantages: the retaining force is finely adjustable since plastic parts have a very low elastic modulus and offer the possibility to apply a load beyond the limit of elasticity by a corresponding dimensioning and to thus set the maximum retaining force. In this way the use of springs will become unnecessary, and damages due to excessive retaining forces are securely avoided. Furthermore it is not necessary to remove the temporary retaining device in an elaborate manner since it is electrically insulated anyway and therefore cannot cause short circuits. Above that the temporary retaining device will disintegrate upon activation of the high temperature fuel cell stack and leave the system environment in the gaseous state. Said gasses (for example CO₂ and H₂O) are not detrimental to the environment and the fuel cell. In this connection the transfer of the retaining force from the temporary restraint to a final restraint takes place automatically, and no further handling action is required. A risk of causing damages during the transfer from the temporary restraint to the final restraint due to handling errors does not exist. If an external final retaining system is used in accordance with DE 195 066 690 A1, DE 103 08 382 B3 or JP 11007975 A the elaborate and expensive removal of the temporary retaining device and of the sealing of the orifices in the insulation can be omitted.

Preferably the high temperature fuel cell stack according to the invention has no retaining elements protruding upwards and downwards and can therefore readily be mounted in the system. Stacking a plurality of sub-stacks (30 cell module) to form a complete fuel cell stack (60 or 90 cells) is then possible as well without problems.

Even though this is not shown the temporary retaining device may, within the framework of the present invention, at least partly and/or in portions extend through the repetitive units of the high temperature fuel cell stack 10.

The features of the invention disclosed in the above description, in the drawings as well as in the claims may be important for the realisation of the invention individually as well as in any combination.

### LIST OF REFERENCE NUMERALS

10 high temperature fuel cell stack
12 plastic shell
14 plastic screw
16 plastic nut
18 plastic strip/plastic cable binder
20 shrinking foil
22 plastic rod
24 repetitive element
26 end plate
28 end plate
30 flap

1. A high temperature fuel cell stack retained by a temporary retaining device, characterised in that the temporary retaining device consists of a plastic material burning at a temperature which is lower than the operating temperature of the high temperature fuel cell stack.

2. The high temperature fuel cell stack of claim 1, characterised in that the plastic material comprises polymeric plastic material, particularly polypropylene and/or polyethylene.

3. The high temperature fuel cell stack claim 1, characterised in that the temporary retaining device comprises at least one plastic screw, at least one plastic nut, at least one plastic strip, at least one plastic shell, at least one plastic rod and/or a shrinking foil.

4. The high temperature fuel cell stack of claim 1, characterised in that the high temperature fuel cell stack comprises two at least substantially parallel end plates retained towards each other by means of the temporary retaining device, and in that the temporary retaining device does not or only slightly protrude beyond the end plates.

5. A method for temporarily retaining a high temperature fuel cell stack, characterised in that it comprises the following step:
retaining the high temperature fuel cell stack by means of a temporary retaining device consisting of a plastic material burning at a temperature which is lower than the operating temperature of the high temperature fuel cell stack.

6. The method of claim 5, characterised in that the plastic material comprises polymeric plastic material, particularly polypropylene and/or polyethylene.

7. A method for removing a temporary retaining device of a high temperature fuel cell stack, characterised in that it comprises the following step:
activating simultaneously the high temperature fuel cell stack and combustioning of the temporary retaining device.

8. The method of claim 7, characterised in that the plastic material comprises polymeric plastic material, particularly polypropylene and/or polyethylene.

9. A high temperature fuel cell stack comprising at least one plastic screw, at least one plastic nut, at least one plastic strip, at least one plastic shell, at least one plastic rod and/or of a shrinking foil as a temporary retaining device for a high temperature fuel cell stack.

10. The fuel cell stack of claim 9, characterised in that the plastic material comprises polymeric plastic material, particularly polypropylene and/or polyethylene.
